(19) United States
(12) Patent Application Publication
(10) Pub. No.: US 2024/0382043 A1
(43) Pub. Date: Nov. 21, 2024

(54) Dual-Use Tool

(71) Applicants: Kevin SIRKIN, Sparks, NV (US); Alicia Koniuk SIRKIN, Sparks, NV (US)

(72) Inventors: Kevin SIRKIN, Sparks, NV (US); Alicia Koniuk SIRKIN, Sparks, NV (US)

(21) Appl. No.: 18/317,645

(22) Filed: May 15, 2023

(51) Int. Cl. A47J 43/28; A24F 9/00; A45D 40/00; B25G 1/10

(52) U.S. Cl. CPC A47J 43/288; A24F 9/00; A45D 40/00; B25G 1/10; A45D 2040/0006; A47G 21/04

(57) ABSTRACT

The present invention discloses a double-sided thermoplastic spatula for fully consuming concentrates from containers or jars. The double-sided thermoplastic spatula includes a metal protruding dabber on other side to provide a second scraping tip for consuming concentrates fully. The double-sided thermoplastic spatula is applied in various industries including make-up industries, tobacco related industries, concentrate consumption, smoke shop industry, medical marijuana industry.

### FIELD OF THE INVENTION

The present invention relates to field of tools for extracting concentrates from jars or container. More particularly, the present invention relates to a thermoplastic spatula for fully extracting concentrates from jars or containers, thereby utilizing residual content or concentrates from the same.

### BACKGROUND OF THE INVENTION

In many industries, products such as lotions, make-up, hair products, tobacco, medical marijuana industries are packaged in bottles, jars, tubes and alike containers. For fully consuming contents from these bottles and alike containers, a user generally squeezes or shakes the contents out of the same. However, when the contents runs low, its becomes more and more difficult for the user to squeeze or shake the remaining contents out of the container as the content filled in the bottles, jars, tubes and alike containers is thick and highly viscous in composition. As a result, the user simply disposes off or throws away the bottles or alike containers without utilizing content left in the containers.

Containers, for example bottles, jars, tubes, cans, or alike for materials of a viscous nature or the like, come in various shapes and sizes. For example, the containers may be any shape, for example the container is cylindrical in shape and constructed with ribbed sidewalls, indentations in the bottom or top portions and alike. The ribbed sidewalls and indentations or other contours form the structure of the container, may trap contents or concentrates therein. The contents trapped in these contours is difficult sometimes to remove with existing tools, and in some instances, more than one tool is required to remove all the contents. As a result, additional unnecessary tools need to be cleaned after the contents are extracted or a portion of the contents is wasted or discarded. There are various tools available for fully consuming or extracting contents from the jars, bottles, tubes and alike containers.

A US Publication 20200383506 assigned to Hadron Gear LLC discloses a multifunctional utensil configured for eating, cooking, and cleaning. The utensil is comprised of a first part and a second part, and includes a spoon on one end of a handle and a fork on the other end of the handle, with additional unique features that enhance cleaning functionality. Although, the multifunctional utensil used for dual purposes. However, this multifunctional utensil does not have any utilization for scraping or removing residual contents.

Another U.S. design patent application 889747 assigned to Kothamasu Jewelry Mart discloses a make-up spatula. Although, the design patent application clearly shows one end of the make-up spatula used for scraping contents out of the tubes, bottles, jars and alike containers. However, the makeup spatula is not the double side usable tool.

Yet another US Publication 20130313847 assigned to Wendy Tortatice discloses a content extraction device useful for removing or extracting the remaining contents of a partially empty container such as a bottle, or tube so that the remaining contents are not wasted. The content extraction device comprised of an elongated body portion and a head portion of varying shape and size that may be removably attached to one or both ends of the elongated body portion and used to remove the remaining contents of a package, such as a tube, bottle or the like. Although, the device described herein fully removes or extracts the remaining contents of the partially empty container. However, only one end of the content extraction device is useful and the user requires has to juggle for accessing multiple tools for removing concentrates from jars or containers.

Another US Publication 20150250361 assigned to Nedra Marion discloses a deformable product extraction tool used to spread condiments or obtain condiments from jars. Although, the deformable product extraction tool utilizes both ends for obtaining condiments from jars. However, the deformable product extraction tool is not strong enough for scraping residual contents from jars or container including hard or dry contents left.

A product titled as “Eisco™ Teflon Coated Spatula” discloses a Teflon coated spatula that includes one flat end and one spoon end. Another, product tilted as “Mini Small Tip Spatula Set” discloses a dual-ended silicone scraper beauty spatula with spoon for kitchen jars butter cream cosmetic bottles. Another product titled as “Spatty daddy's Makeup spatula” including a scraping component at one end and a handle for the user to grasp and provide proper pressure and extract residual content from the jars or containers. The scraper is triangular in shape.

Another product titled as “Every drop's beauty spatula” includes a scraper at one end and a handle on the other end for user's grasping. The scraper used herein is of square shape for proper positioning of the scraper from the containers. Another product titled as “OKSILICONE Wholesale Factory Price Small Silicone Spatula Food Safe Heat Resistant Spatulas Cream Jar Bottle Scraper” discloses a spatula including spoon at one end and scraper at another end for scraping and scooping contents out of the containers.

Both Spatty daddy's and Every drop's makeup spatula, are focused towards beauty products and utilized only one end for scraping residual contents from the bottles, tubes, jars or containers. Both Spatty daddy's and Every drop's makeup spatula are not strong enough for extracting hard or dry residual contents from bottles tubes, jars or containers, thus they both can't be utilized for general purposes. Additionally, both does not have protruding metal dabber tip, so have no applicability in industries such as tobacco and medical industries.

Although each product described utilizes both ends for scraping residual content from the jars, bottles, tubes or containers but are focused towards beauty products. They do not focus towards general niche or markets. However, the scraper disclosed is of single material and useful for cosmetics or make-up industries but not for medical concentrates or smoking accessories. Additionally, the scrapers disclosed not being able to get inside a corner or nook inside a jar of hash or medicine and efficiently removing the content from the jar of hash or medicine. Therefore, the present invention is designed to address the peculiar challenges in the prior art, the present invention discloses an efficient and multi-purpose tool for fully extracting contents from the jars or containers.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to provide an efficient thermoplastic spatula for fully utilizing contents available in the jars or containers.

### SUMMARY OF THE INVENTION

In accordance with the present invention, the disadvantages and limitations of the prior art are substantially avoided by providing a double-sided thermoplastic spatula for fully consuming contents or concentrates available in the jars or containers. The thermoplastic spatula for consuming concentrates includes a scraper and a handle. The handle includes a proximal end and a distal end. The proximal end of the handle is heat sealed to the scraper. The distal end of the handle includes a central opening configured for receiving a metal protruding dab. The metal protruding dabber includes a first end and a second end. The first end of the metal protruding dabber is inserted in the central opening of the handle. The first end of the metal protruding dabber includes a tip for scraping and thus fully consuming concentrates.

In order to ensure effective usage of leftover contents from the walls of the container, it is necessary to impart a pre-determined outwardly directed radial force to the thermoplastic spatula. A user grabs the handle and further utilizes either scraper or metal protruding dabber for emptying the jars or containers, depending upon the contents available in the same.

The primary objective of the present invention is to provide an efficient thermoplastic spatula for fully consuming concentrates from jars or containers by utilizing both ends, thus a user need not to juggle for using multiple scraping tools at a single time.

An objective of the present invention is to provide a thermoplastic spatula is flexible in use that adapt itself to curved or irregular surfaces of containers, bottle or jars and alike to remove residual contents or other particles therefrom.

Another objective of the present invention is to provide a thermoplastic spatula in an implement of the form by which residual contents or other particle present in bottles, jars and alike containers may be expeditiously and easily removed therefrom.

Yet another objective of the present invention is to provide an adjustable thermoplastic spatula, which adapts itself to the surface contour of the bottles, jars or containers so as to effectively remove residual or unused contents from the same.

Another objective of the present invention is to provide a uniquely molded tool for example the thermoplastic spatula including metal protruding dabber for use to dabber or consuming concentrates, which is of extremely simple construction and therefore inexpensive to manufacture and yet which is remarkably effective for its intended purposes.

Yet Another objective of the present invention is to provide a thermoplastic spatula with exposed metal tip for fully consuming concentrates of jars or container used in tobacco related industry, concentrate consumption, smoking accessories, and medical marijuana industry.

An objective of the present invention is to provide a thermoplastic spatula with safe grade titanium tip as titanium transfers heat opposed to stainless steel, thus allows less wastage of concentrates.

Another objective of the present invention is to provide a thermoplastic spatula including titanium dabber having more strength for use to dabber or consuming concentrates.

Yet another objective of the present invention is to provide a thermoplastic spatula with metal protruding dabber rod with deeper length for more structural strength.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a thermoplastic spatula for consuming or extracting concentrates from jars or containers in accordance with the present invention;

FIG. 2 illustrates an exploded view of the thermoplastic spatula including a scraper, a handle and a metal protruding dabber for consuming or extracting concentrates from jars or containers in accordance with the present invention;

FIG. 3 illustrates insertion of the metal protruding dabber within the handle of the thermoplastic spatula in accordance with the present invention;

FIG. 4 illustrates a cross-sectional view of the thermoplastic spatula for consuming or extracting concentrates from jars or containers in accordance with the present invention;

FIG. 5(A) illustrates insertion of the metal protruding dabber in semi-inserted position within the handle of the thermoplastic spatula in accordance with the present invention;

FIG. 5(B) illustrates insertion of the metal protruding dabber in fully inserted position within the handle of the thermoplastic spatula in accordance with the present invention; and

FIG. 6(A) illustrates the thermoplastic spatula including a spoon shaped tip at the second end of the metal protruding dabber in accordance with the present invention;

FIG. 6(B) illustrates the thermoplastic spatula including a triangle shaped tip at the second end of the metal protruding dabber in accordance with the present invention;

FIG. 6(C) illustrates the thermoplastic spatula including a circular tip at the second end of the metal protruding dabber in accordance with the present invention; and

FIG. 6(D) illustrates the thermoplastic spatula including a scraper shaped tip at the second end of the metal protruding dabber in accordance with the present invention.

### DETAILED DESCRIPTION OF THE DRAWINGS

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 212. ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

The present invention discloses an efficient and a double-sided thermoplastic spatula for fully consuming concentrates from jars or containers by utilizing both ends, thus a user need not to juggle for using multiple scraping tools at a single time. The thermoplastic spatula including metal protruding dabber to dabber or to consume concentrates fully. The thermoplastic spatula with exposed metal tip for fully consuming concentrates of jars or container used in tobacco related industry, concentrate consumption, smoking accessories, and medical marijuana industry.

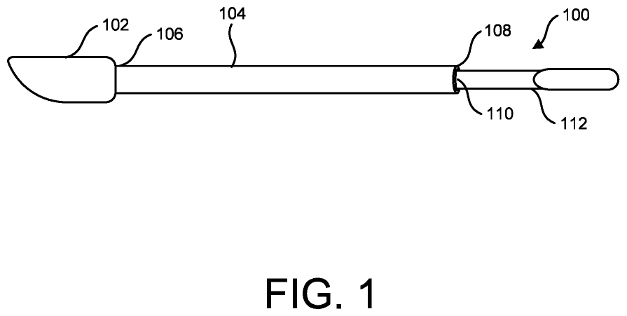

FIG. 1 illustrates a thermoplastic spatula (100) for consuming or extracting concentrates from jars or containers in accordance with the present invention. The thermoplastic spatula (100) for fully consuming contents or concentrates available in the jars or containers. The thermoplastic spatula (100) for consuming concentrates includes a scraper (102) and a handle (104).

Further, the handle (104) includes a proximal end (106) and a distal end (108). In one embodiment of the present invention, the proximal end (106) of the handle (104) is heat sealed to the scraper (102). In preferred embodiment of the present invention, the handle (104) is either a rod, bar and alike structures.

In various embodiments of the present invention, the scraper (102) and the handle (104) are of integral construction made up of thermoplastic material. The scraper (102) and the handle (104) either made up of hardened thermoplastic material or flexible thermoplastic material depending on the applicability of the tool. In preferred embodiment of the present invention, the scraper (102) and the handle (104) is made up of flexible and less rigid thermoplastic material. Examples of thermoplastic material are such as but not limited to soft plastics, deformable plastics, rubber or silicone structure. In preferred embodiment of the present invention, the scraper (102) and the handle (104) is made up of silicone material.

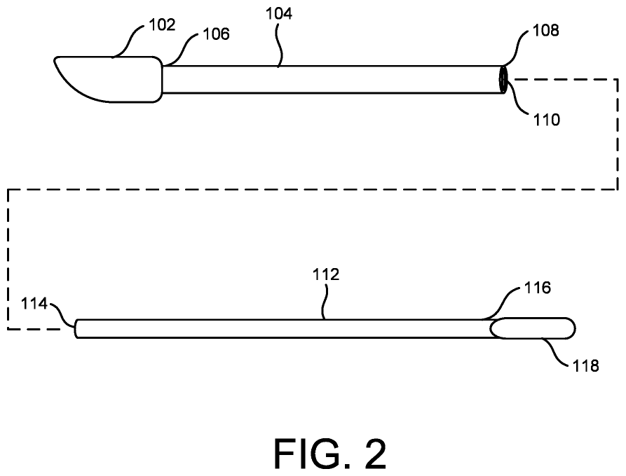

FIG. 2 illustrates the exploded view of the thermoplastic spatula (100) including a scraper (102), a handle (104) and a metal protruding dabber (112) for consuming or extracting concentrates from jars or containers. The scraper (102) is in form of knife or blade like structure for extracting content from the container, specifically, extracting the residual or leftover contents in the jars or containers.

Further, the thermoplastic spatula (100) includes the handle (104) includes a proximal end (106) and a distal end (108). The proximal end (106) of the handle (104) is heat sealed to the scraper (102). In preferred embodiment of the present invention, the handle (104) is either a rod, bar and alike structures. Further, the distal end (108) of the handle (104) includes a central opening (110) configured for receiving a metal protruding dabber (112). The central opening (110) may be a hole, aperture and alike structures. In preferred embodiment of the present invention, the central opening (110) is circular in shape configured for receiving the metal protruding dabber (112) and thus enable the thermoplastic spatula (100) to be used by both the scraper (102) and the metal protruding dabber (112).

The scraper (102) and the handle (104) either made up of hardened thermoplastic material or flexible thermoplastic material depending on the applicability of the tool. In preferred embodiment of the present invention, the scraper (102) and the handle (104) is made up of flexible and less rigid thermoplastic material. Examples of thermoplastic material are such as but not limited to soft plastics, deformable plastics, rubber or silicone structure. In preferred embodiment of the present invention, the scraper (102) and the handle (104) is made up of silicone material.

Further, the metal protruding dabber (112) includes a first end (114) and a second end (116). The first end (114) of the metal protruding dabber (112) is inserted in the central opening (110) of the handle (104). Further, the second end (116) of the metal protruding dabber (112) includes a tip (118) for scraping and thus fully consuming concentrates. The thermoplastic spatula (100) with exposed metal tip (118) for fully consuming concentrates of jars or container used in tobacco related industry, concentrate consumption, smoking accessories, and medical marijuana industry.

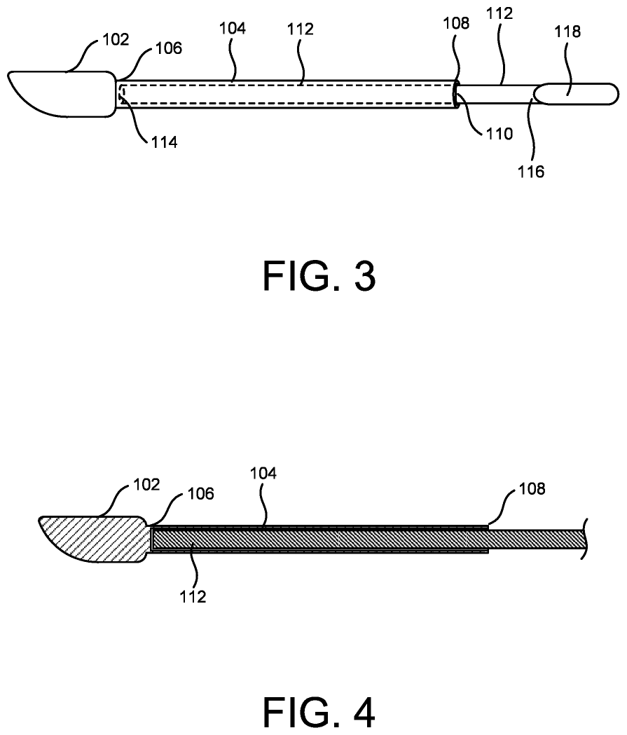

FIG. 3 illustrates insertion of the metal protruding dabber (112) within the handle (104) of the thermoplastic spatula (100) in detail. Further, the metal protruding dabber (112) includes a first end (114) and a second end (116). The first end (114) of the metal protruding dabber (112) is inserted through the central opening (110) of the handle (104). Further, the second end (116) of the metal protruding dabber (112) includes a tip (118) for scraping and thus fully consuming concentrates. The shape of the metal protruding dabber (112) is in rod, bar, shaft and alike forms. In preferred embodiment of the present invention of the metal protruding dabber (112) is in rod shape including the tip (118) at the second end (116) for removing the leftover concentrates from the jars, bottles and alike containers.

In various embodiment of the present invention, the metal protruding dabber (112) is made up of metal, plastics, and the like materials. In an exemplary embodiment of the present invention, the metal protruding dabber (112) is made up of steel, aluminum, copper and alloys of the metals and alike materials. In preferred embodiment of the present invention, the metal protruding dabber (212) is made up of transition metal such as titanium metal and alloys of titanium.

FIG. 4 illustrates a cross-sectional view of the thermoplastic spatula (100) in accordance with the present invention. The metal protruding dabber (112) includes a first end (114) and a second end (116). The first end (114) of the metal protruding dabber (112) is inserted through the central opening (110) of the handle (104). As shown in the FIG. 4, the first end (114) of the metal protruding dabber (112) reaches till the proximal end (106) of the handle (104). The handle (104) of the thermoplastic spatula (100) includes a cylindrical cavity for receiving the metal protruding dabber (112).

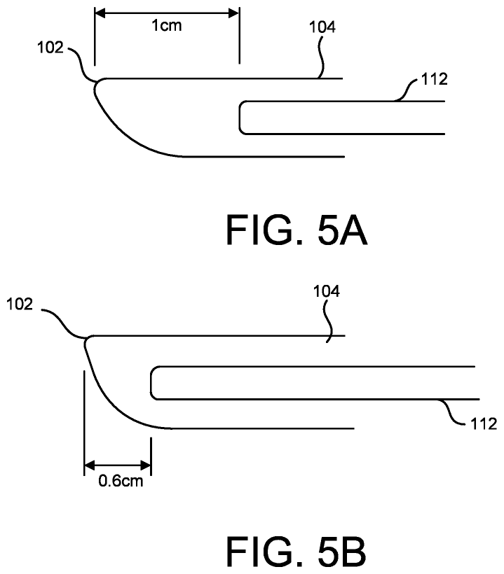

FIG. 5A illustrates insertion of the metal protruding dabber (112) in semi-inserted position within the handle of the thermoplastic spatula (100). The first end (114) of the metal protruding dabber (112) is inserted through the central opening (110) to the handle (104) of the thermoplastic spatula (100). In preferred embodiment of the present invention, in semi-inserted position of the metal protruding dabber (112) within the handle (104) of the thermoplastic spatula (100), the distance of the metal protruding dabber (112) within the scraper (102) is 1 cm.

FIG. 5B illustrates insertion of the metal protruding dabber (112) in fully inserted position within the handle (104) of the thermoplastic spatula (100). In fully inserted position of the metal protruding dabber (112) within the handle (104) of the thermoplastic spatula (100), the distance of the metal protruding dabber (112) within the scraper (102) is 0.6 cm.

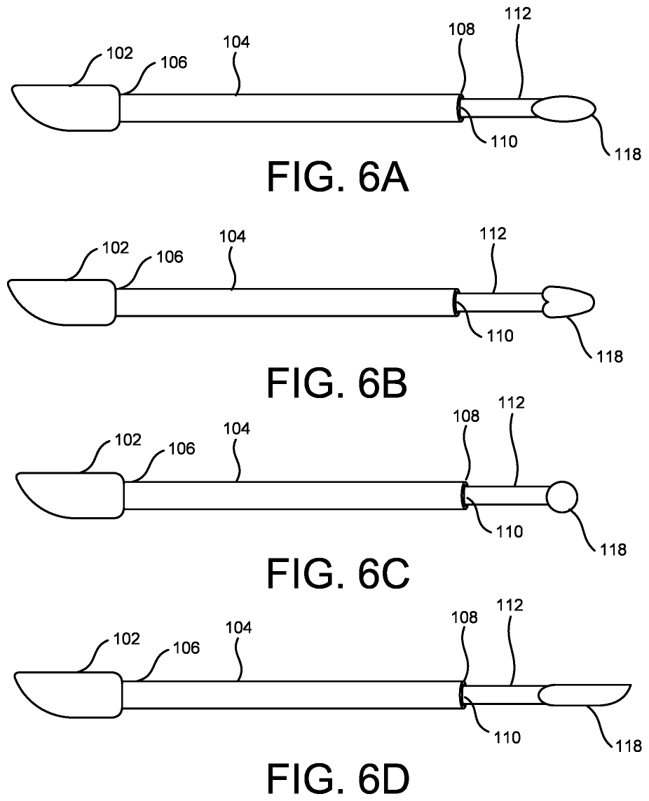

FIG. 6A illustrates the thermoplastic spatula (100) including the tip (118) of the metal protruding dabber (112) in spoon shape. In various embodiment of the present invention, the metal protruding dabber (112) is made up of metal, plastics, and the like materials. In an exemplary embodiment of the present invention, the metal protruding dabber (112) is made up of steel, aluminum, copper and alloys of the metals and alike materials. In preferred embodiment of the present invention, the metal protruding dabber (112) is made up of transition metal such as titanium metal and alloys of titanium.

Containers, for example bottles, jars, tubes, cans, or alike is cylindrical in shape and constructed with ribbed sidewalls, indentations in the bottom or top portions and alike. The ribbed sidewalls and indentations or other contours form the structure of the container, may trap contents or concentrates therein. The contents trapped in these contours are difficult sometimes to remove with the thermoplastic spatula (100).

The tip (118) of the metal protruding dabber (112) is in spoon shape for scooping concentrates from the jars or containers. The spoon shaped tip (118) used for removing contents trapped in these contours of the jars, bottles or alike containers.

FIG. 6B illustrates the thermoplastic spatula (100) including the tip (118) of the metal protruding dabber (112) in triangular shaped scraper. The contents trapped in the contours of the jars, bottles or alike containers is removed from the ribbed sidewalls and indentations or other contours. A user inserts the triangular shaped scraper (118) within the jars, bottles or alike containers, and applies pressure for extracting residual concentrates from the jars, bottles or alike containers.

FIG. 6C illustrates the thermoplastic spatula (100) including the tip (118) of the metal protruding dabber (112). The contents trapped in the contours of the jars, bottles or alike containers is removed from the ribbed sidewalls and indentations or other contours. A user inserts the circular shaped scraper (118) within the jars, bottles or alike containers, and applies pressure for extracting residual concentrates from the jars, bottles or alike containers.

FIG. 6D illustrates the thermoplastic spatula (100) including the tip (118) of the metal protruding dabber (112) in scraper shape in accordance with the present invention. In preferred embodiment of the present invention, the shape of the tip (118) in scraper form. A user inserts the knife shaped scraper (118) within the jars, bottles or alike containers, and applies pressure for extracting residual concentrates from the jars, bottles or alike containers. The contents trapped in the contours of the jars, bottles or alike containers is removed from the ribbed sidewalls and indentations or other contours.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A thermoplastic spatula, wherein the thermoplastic spatula comprising:
a scraper;
a handle with a proximal end and a distal end, wherein the proximal end of the handle is connected to the scraper, further wherein the distal end of the handle includes a central opening; and
a metal protruding dabber with a first end and a second end, wherein the second end is inserted within the central opening and the first end includes a tip for consuming concentrates.

2. The thermoplastic spatula in accordance with claim 1, where the scraper and the handle are of integral construction.

3. The thermoplastic spatula in accordance with claim 1, where the scraper and the handle are of silicon material.

4. The thermoplastic spatula in accordance with claim 1, wherein shape of the metal protruding dabber is either of a rod, a shaft or a bar.

5. The thermoplastic spatula in accordance with claim 1, wherein the metal protruding dabber is made up of titanium or titanium alloy.

6. The thermoplastic spatula in accordance with claim 1, wherein the consuming concentrates are selected from one or more of medical concentrates, food concentrates, tobacco concentrates, marijuana concentrates, beauty make-up concentrates.

7. The thermoplastic spatula in accordance with claim 1, wherein the metal protruding dabber inserted in the central opening through heat sealing process.

8. The multi-purpose tool in accordance with claim 1, wherein the metal protruding dabber is shaped as either spoon or scoop.
